(19) United States
(12) Patent Application Publication
(10) Pub. No.: US 2013/0301011 A1
(43) Pub. Date: Nov. 14, 2013

(54) ADVANCED LIGHTPIPE HOMOGENIZER

(71) Applicants: Kirk Cook, Lyons, CO (US); Bradley Sissom, Boulder, CO (US); Dennis Joseph Gallagher, Boulder, CO (US); Lin Li, Boise, ID (US)

(72) Inventors: Kirk Cook, Lyons, CO (US); Bradley Sissom, Boulder, CO (US); Dennis Joseph Gallagher, Boulder, CO (US); Lin Li, Boise, ID (US)

(21) Appl. No.: 13/468,551

(22) Filed: May 10, 2012

(51) Int. Cl. G03B 21/14; F21V 8/00

(52) U.S. Cl. 353/30; 362/551

(57) ABSTRACT

A faceted lightpipe arrangement and method have been described for use with an imaging projector system. A plurality of facets can be arranged to receive beams of light and to converge the beams of light while traveling from an input end to an output end of the lightpipe. The faceted lightpipe provides for a high degree of color mixing and a high degree of intensity uniformity.

### BACKGROUND

Embodiments of the present invention are generally related to the field of projector systems and, more particularly, to the field of ultra compact high performance projector systems.

Expanding use of computers, handheld devices, tablets and other computation electronic devices is rapidly fueling increasing production, viewing and sharing of videos as well as stationary images, especially including digitized images that can be displayed, stored and transferred based on digital electronic signals.

While conventional displays, such as LCD panels, are commonly utilized as visual monitors for desktop and/or laptop computers, projector systems are sometimes employed, typically as external peripheral devices, to serve as an auxiliary display that can be advantageous at least in certain applications. In many cases, a given projector system may be configured, as an external peripheral device, to provide at least a reasonably portable means for projecting a video and/or stationary image that is substantially larger than the projector system. For example, high performance projector systems commonly employed in the context of business meetings, sales pitches and presentations, may be of sufficiently small overall size for at least reasonably convenient transport by way of a briefcase, and may be capable of displaying high quality and high brightness images on a projection screen. These projectors may be configured to produce the projected image in response to an electronic signal from computers and many other electronic devices.

There are numerous well known configurations of traditional projector systems, many of which include some type of illuminator arrangement. As will be described hereinafter, the illuminator arrangement may be instrumental in providing sufficient brightness for projected images of reasonably large size. In this regard, it is recognized that traditional approaches are limited with respect to the competing interests of miniaturization in conjunction with providing high brightness.

The foregoing examples of the related art and limitations related therewith are intended to be illustrative and not exclusive. Other limitations of the related art will become apparent to those of skill in the art upon a reading of the specification and a study of the drawings.

### BRIEF DESCRIPTION OF THE DRAWINGS

FIG. 1 is a diagrammatic plan view of a projector system.

FIG. 2 is a diagrammatic plan view of a compact low profile projector system.

FIG. 3 is a diagrammatic perspective view, of an illuminator arrangement.

FIG. 4A is a diagrammatic perspective view of a non-faceted lightpipe.

FIG. 4B is a diagrammatic perspective view illustrating additional aspects with respect to operation of the non-faceted lightpipe of FIG. 4A.

FIG. 5A is a map of an output light distribution that can be produced using one embodiment the non-faceted lightpipe of FIG. 4A.

FIG. 5B is a map of an output light distribution that can be produced using another embodiment of the non-faceted lightpipe of FIG. 4A.

FIG. 6A is a diagrammatic perspective view of a faceted lightpipe.

FIG. 6B is a diagrammatic cutaway view, in perspective, of an input portion of the faceted lightpipe of FIG. 6A.

FIG. 7 is a diagrammatic perspective view illustrating aspects of operation with respect to an embodiment including the faceted lightpipe of FIG. 6 in series with the illuminator arrangement of FIG. 3.

FIG. 8 is a map of an output light distribution that can be produced based on the embodiment of FIG. 7.

FIG. 9 is a graph illustrating plots of light intensity, including a first plot based on an embodiment of the faceted lightpipe of FIG. 6A, and a second plot based on an embodiment of the non-faceted lightpipe of FIG. 4A.

FIG. 10 is a graph illustrating plots of color value, including a first plot based on an embodiment of the faceted lightpipe of FIG. 6A, and a second plot based on an embodiment of the non-faceted lightpipe of FIG. 4A.

### DETAILED DESCRIPTION

The following description is presented to enable one of ordinary skill in the art to make and use embodiments of the invention and is provided in the context of a patent application and its requirements. Various modifications to the described embodiments will be readily apparent to those skilled in the art and the generic principles taught herein may be applied to other embodiments. Thus, the present invention is not intended to be limited to the embodiments shown, but is to be accorded the widest scope consistent with the principles and features described herein including modifications and equivalents, as defined within the scope of the appended claims. It is noted that the drawings are not to scale and are diagrammatic in nature in a way that is thought to best illustrate features of interest. Descriptive terminology may be adopted for purposes of enhancing the reader's understanding, with respect to the various views provided in the figures, and is in no way intended as being limiting.

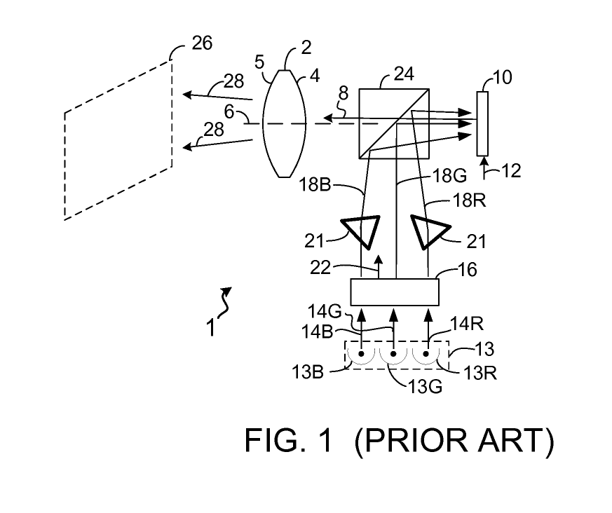

Attention is now directed to the figures wherein like reference numbers may refer to like components throughout the various views. FIG. 1 is a diagrammatic view, in elevation, of an embodiment of a prior art projector system generally indicated by reference number 1. Projector system 1 includes an imaging lens arrangement 2, generally defining an entrance side 4 and an exit side 5. While imaging lens arrangement 2 is schematically represented using a single lens, many commercially available projector systems utilize a plurality of lenses (not shown) as a practical technique for projecting high quality images. The imaging lens arrangement defines an optical axis 6 that is aligned to receive and project an object image 8, indicated in the figure using an arrow that emits from a display 10. The display may be a pixelated display that can be illuminated by approximately uniform light at least having approximately uniform intensity, causing the display to emit object image 8 responsive to an electronic signal 12. Initial non-uniform beams of light can be initially produced by an illuminator arrangement 13 having one or more light sources. An embodiment of illuminator arrangement 13, as illustrated in FIG. 1, can include three light sources 13R, 13G and 13B configured to produce initial non-uniform beams of light 14R, 14G, and 14B, respectively. In the case of color image projectors, the sources may be different colors selected according to well known methods for producing a complete spectrum of colors based on various combinations thereof. In one non-limiting example, the different colors can include red, green and blue. In another example, the different colors can include yellow, cyan and magenta. The initial beams of light can be received by a homogenizer arrangement 16, which can be configured to spatially homogenize the initial beams of light to produce beams of homogenized light 18R, 18G, and 18B having at least approximately uniform intensity at least at the plane of the display. In the case of a color projector having sources of different colors, the homogenizer may be further configured, based on various well known techniques, for color mixing of the beams. In order to facilitate this mixing, many conventional projector systems employ reflective and or refractive optical components in order to converge light from various ones of the sources, so that the uniform light beams from the different sources converge together to illuminate display 10. In many commercially available embodiments, prisms 21 may be arranged to converge uniform light beams 18R, 18G, and 18B with one another, towards display 10, as indicated in FIG. 1 using a set of three converging arrows.

The light sources and the homogenizer can be arranged such that uniform light beams 18R, 18G, and 18B each initially propagate, at least generally, in a given direction 22 that is not directed toward the display. This uniform light may be received by a beamsplitter 24 and redirected for incidence onto a major surface of display 10. Based on well known principles of optics, the beamsplitter may be a polarizing beamsplitter PBS, or a polarizing beamsplitter cube, configured such that a majority of the uniform light is redirected towards the display. Furthermore, a majority of light forming object image 8, may exhibit a polarization that is appropriately oriented to pass straight through the beamsplitter for reception by imaging lens arrangement 2. Imaging lens arrangement 2 may be configured to receive object image 8 which propagates through imaging lens arrangement 2 to produce a projected image 26, based on projected light 28 that exits the imaging lens arrangement from exit side 5. A person of ordinary skill in the art, having this disclosure in hand, should appreciate that a high degree of intensity uniformity of projected image 26 can depend, at least to a substantial extent, on a high degree of uniformity of object image 8.

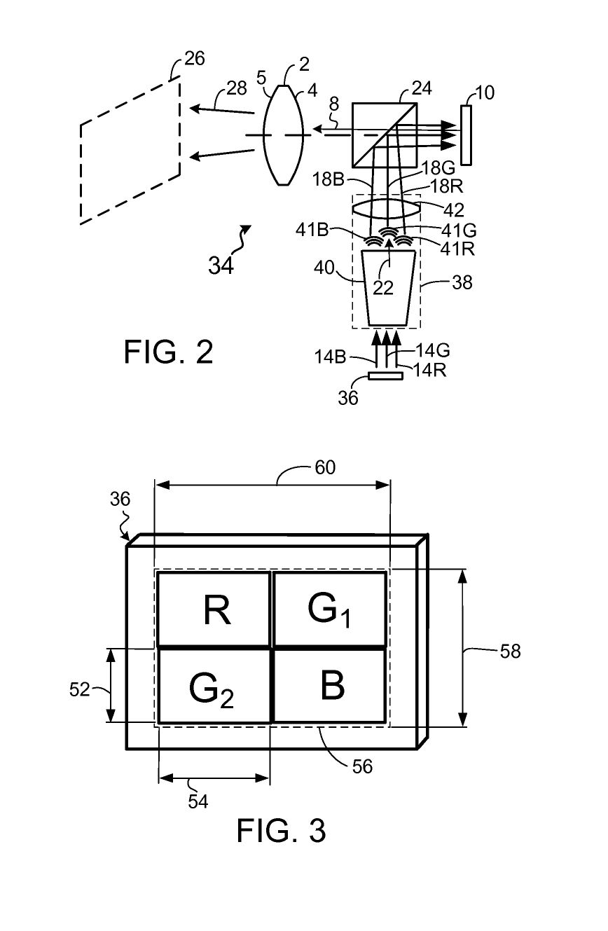

FIG. 2 is a diagrammatic view, in elevation, of an embodiment of a compact projector system, produced according to the present disclosure, and generally indicated by reference number 34. Projector system 34 includes an imaging lens arrangement 2, a beamsplitter 24, an illuminator arrangement 36, a display 10 and a homogenizer arrangement 38. Homogenizer arrangement 38 can include including a lightpipe 40 and a displacement lens 42. At least in advanced, compact embodiments, these components can be arranged to produce a compact projector with sufficiently low volume and low profile such that the projector may fit within handheld devices such as cell phones. It is noted that a lightpipe can facilitate compactness, at least for the reason that a lightpipe can be configured to exhibit a low height profile as compared with many conventional homogenizer arrangements using lens arrays and/or prisms. For at least these reasons, it is submitted that lightpipes can be regarded as facilitating compact size.

Lightpipe 40 can be configured to receive initial light beams 14R, 14G and 14B, and to produce therefrom output light distributions 41R, 41G and 41B, respectively, which are shown as wavefronts as will be described in greater detail hereinafter. Displacement lens 42 can be configured to image these output light distributions to produce corresponding homogenized light beams 18R, 18G, and 18B, respectively and to focus these homogenized light beams onto display 10 to provide for at least approximately uniform illumination thereof. As was the case with respect to projector 1 (FIG. 1), homogenized light beams 18R, 18G, and 18B may initially propagate, at least generally, in a given direction 22 that is not directed toward the display, and these light beams may be received by beamsplitter 24 and redirected for incidence onto a major surface of display 10.

As described previously, a high degree of intensity uniformity, with respect to lateral variations in illumination of display 10, tends to facilitate a correspondingly high degree of uniformity with respect to lateral variations in projected image 26. It is noted that the projector system of FIG. 2 can include a plurality of light sources, and that any given image may be produced based on a variety of combinations of one or more of the initial light beams produced thereby. Therefore, a high degree of intensity uniformity associated with each individual one of the homogenized beams, produced by the homogenizer responsive to the initial light beams, can tend to facilitate correspondingly a high degree of intensity uniformity with respect to projected images, irrespective of the number of initial light beams on which those projected images are based.

With regard to embodiments of color projectors that rely on color mixing of a plurality of different color light sources, including but not limited to color projectors that utilize red, green and blue light sources, it can be appreciated that the aforedescribed high degree of intensity uniformity can confer further benefits, including, but not limited to facilitating a correspondingly high degree of uniformity with respect to lateral variations in color. In particular, a high degree of intensity uniformity, in the illumination of the display by each one of a plurality of different color light sources, can facilitate, at least in part, a correspondingly high degree of color uniformity, in the illumination of the display, by any simultaneous combination of two or more of these light sources. In other words, for color projector sources using a plurality of different color light sources, any enhancements with respect to intensity uniformity, in the illumination of the display and hence the projected image, can facilitate corresponding enhancements with respect to color uniformity as well.

Attention is now directed to FIG. 3 which illustrates a diagrammatic plan view of a compact embodiment of illuminator arrangement 36, developed by Micron Technology, Inc., useable for producing the initial light beams in the context of embodiments of the projector system such as that of FIG. 2. This light source arrangement, can include an array of four high intensity light emitting diodes (LED'S), including one red LED, two green LEDs and one blue LED indicated in FIG. 3 as R, G₁, G₂, and B, respectively. At least in some embodiments, each LED can serve an individual light source surface having a height 52 of approximately 0.5 mm and a width 54 of approximately 0.5 mm. These light sources may be supported in side-by-side relationships with one another to define a combined illuminator surface 56, represented in the figure using a dashed box, having a height 58 of approximately 1 mm, and a width 60, of approximately 1 mm. With respect to any embodiments that can be configured for producing red, green and blue light beams, it may be desirable to provide these colors in a balanced way such that the power associated with each different color is the same. It is recognized, based on a variety of practical considerations, that any given green LED, configured based on state-of-the-art technology, can tend to produce limited power as compared to similar configurations of red and blue LEDs. At least in order to facilitate a balance of optical power with respect to the red and blue LEDs, the illuminator arrangement can be configured to include two green LED's, as illustrated in FIG. 3.

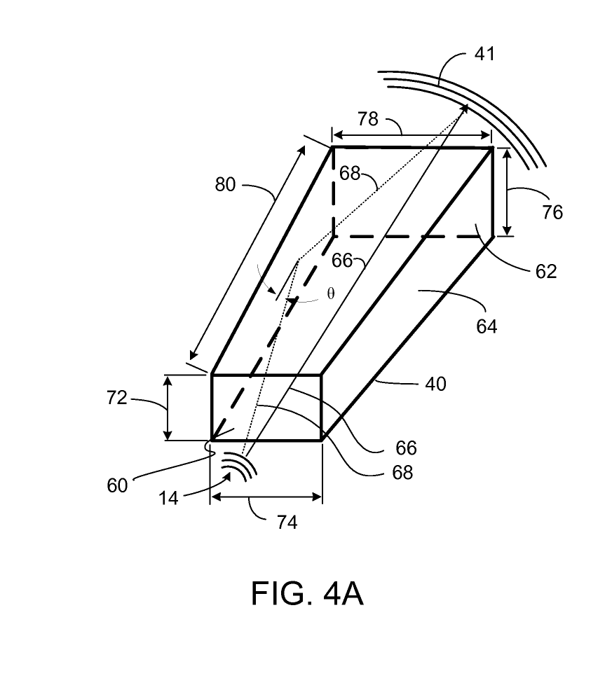

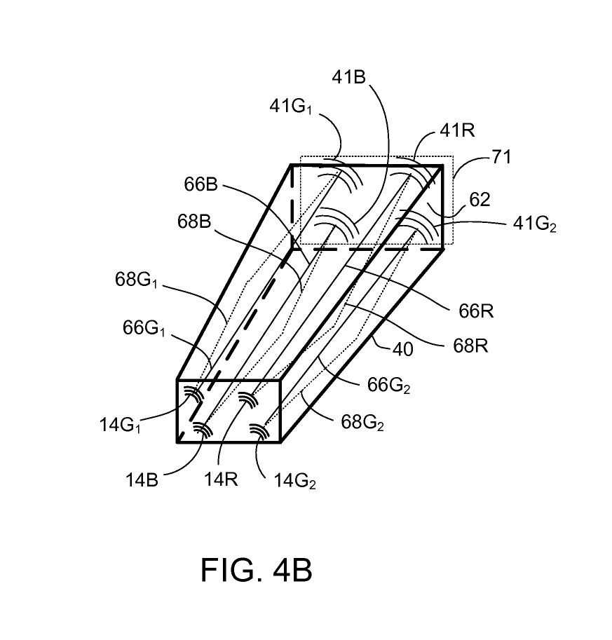

Attention is now directed to FIG. 4A, with ongoing reference to FIGS. 2 and 3. FIG. 4A is a diagrammatic view, in perspective, of a lightpipe 40, that can be configured to serve as the lightpipe in homogenizer 38 of FIG. 2. Lightpipe 40 defines an input end 60 and an output end 62 and a tubular surface 64 extending therebetween, and can be configured with a sufficiently low height profile for use in highly compact embodiments of projector system 1. It is noted that lightpipes may, in accordance with well known terms of art, at times be referred to as “light tubes”, “integration rods” and/or “light tunnels”. Tubular surface 64 at least generally defines a closed shape in cross-section at any given location along the pipe, and the cross section may have any suitable shape including but not limited to square, rectangular, or polygonal shape. With respect to embodiments disclosed herein, the tubular surface can have a rectangular cross section as illustrated in FIG. 4A, and the tubular surface can be tapered such that the lightpipe defines a frusto-pyramidal shape with the output end being larger than the output end. The input end of the illustrated embodiment can be formed as an approximately flat rectangular surface, and can be configured for use with the illuminator arrangement 36, aligned as shown in FIG. 2 for receiving at least a majority of initial light beams 14R, 14G₁, 14G₂ and 14B. In FIG. 4A, a given one of these initial light beams 14 is shown as a wavefront and may be referred to in a generic sense using the single reference number 14.

An initial light beam 14 can be characterized as including a transmitted beam 66, as a portion thereof, that may propagate directly through lightpipe 40 to exit through output surface 62 without impinging upon any portion of the tubular surface, while a reflected portion 68 may be internally reflected by the tubular sidewall to propagate reflectively through the lightpipe such that the first and second portions of light mix with one another to produce output light distribution 41 that exhibits a lower degree of spatial variation as compared to the initial light beam.

It can be appreciated that reflected portion 68 of light can propagate based on complex combinations of multiple paths, each of which paths can include one or more reflections at one or more locations inside tubular surface 64. Likewise, the transmitted portion can travel on any number of paths. For purposes of illustrative clarity, however, the transmitted beam and the reflected portion are schematically indicated in FIG. 4A using only two different rays. Transmitted beam 66 of initial light beam 14 is indicated using a straight ray intended as being illustrative of direct propagation through the lightpipe, while reflected portion 68 of initial light beam 14 is indicated using a bent ray intended as being illustrative of reflections caused by incidence thereof with surface 64 of lightpipe 40. A corresponding output light distribution 41, like initial beam 14, is schematically depicted, as a group of curved wavefronts, in a manner commonly associated with vintage mid-20^{th} century illustrations often associated with radio waves and/or radar signals. This notation has been adopted, as an illustrative technique, in part to emphasize that initial light beam 14 and output light distribution 41 both tend to exhibit intensity patterns that vary transversely across the input and output ends, respectively, of the lightpipe. As described previously with reference to FIG. 2, displacement lens 42 (FIG. 2), can be configured to image output light distribution 41 to produce the homogenized light beams, and to focus these homogenized light beams for illuminating display 10 in a uniform, homogenized way.

It can be appreciated that the projector, including illuminator arrangement 36 therein, can be operated in a variety of different modes including combined and individual modes. With respect to combined modes of operation, a selected plurality of the light sources emit their associated light beams simultaneously, and each light beam propagates through the lightpipe, as described above with reference to FIG. 4A, to produce a corresponding one of a plurality of output distributions. In combined mode of operations, the plurality of output distributions can be regarded as adding with one another to provide a combined output light distribution having a light intensity that varies transversely across the output surface of the lightpipe, as will be described in further detail immediately hereinafter. In the context of embodiments of color image projectors, the light sources may each produce light beams of different colors, such as red, green and blue, and the lightpipe may combine the light, at least for purposes of color mixing in a manner that is suitable for projection of color images. In other embodiments, light from multiple sources can be combined at least for the purpose of increasing brightness as compared with a single source.

Individual modes of operation of light sources can involve a sequential mode of operation for which at least a subset of light sources R, G₁, G₂, and B emit light sequentially, one after the other in sufficiently rapid succession such that integration by a person's eyesight creates at least approximately the same visual appearance as can be provided by simultaneous emission. The output light distributions associated with each of the subset of light sources can sequentially combine to define a resulting combined output light distribution, as a time-averaged output light distribution, that varies transversely across the output end of the lightpipe. Thus, the average output light distribution, for the sequential mode of operation, can exhibit lateral variations of intensity, based at least in part on time-averaged intensity distributions of each of the individual sources. In the case of color image projectors such as that of FIG. 2, the light sources can produce light beams of different colors, such as red green and blue, and the lightpipe can direct the light beams to cause highly uniform illumination of display 10, and subsequent projection of highly uniform images, such that an observer can experience the time averaged combination as an image that at least approximately appears as if the different color beams had been activated simultaneously.

As an embodiment of a color image projector employing a sequential mode of operation, projector system 34 (FIG. 2) can employ a FLCOS pixel array serving as display 10, and the projector system may provide for sequential color mixing, based, at least in part, on dynamic updating of the display, with the FLCOS display and the illuminator arrangement configured to cooperate with one another at least generally in a manner that is known to those familiar with FLCOS displays. The pixel array of the FLCOS panel is capable of extremely fast switching such that it is ideally suited to the display of real time video. Some embodiments of these displays have been configured for illumination by LEDs, such as light sources R, G₁, G₂, and B shown in FIG. 3, however, other suitable light sources can be used without limitation. A field sequential display generally presents video to a viewer by breaking the frames of an incoming video stream into individual red, green and blue subframes. Only one color subframe is presented to the viewer at a time. That is, the pixels of the pixel array can be illuminated at different times by an appropriate color of light associated with the red, green and blue subframes in a way that produces a grayscale image for each subframe. The color subframes can be presented to the viewer so rapidly, however, that the eye of the viewer integrates the individual color subframes into a full color image. In the instance of an incoming video stream, the processing for purposes of generating the subframes is generally performed in real time while the pixels of the display are likewise driven in real time.

Attention is now directed to FIG. 4B, which is a diagrammatic view, in perspective, of lightpipe 40, in a low profile embodiment, configured for receiving light beams 14R, 14G₁, 14G₂ and 14B. The illustration of FIG. 4B can be considered as applicable with respect to various modes operation in which a plurality of light beams are received by lightpipe 40, including but not limited to the combined mode of operation and the sequential mode of operation. In the combined mode of operation, initial light beams 14R, 14G₁, 14G₂ and 14B can be emitted simultaneously by their associated light sources (not shown), to produce transmitted beams 66R, 66G₁, 66G₂, and 66B, illustrated in FIG. 4B using solid lines, and reflected portions 68R, 68G₁, 68G₂ and 68B, respectively. For purposes of illustrative clarity, the reflected portions are illustrated using dashed lines in order that these portions can be readily distinguished from their respective transmitted beams. As described above with reference to FIG. 4A, transmitted beam 66R and reflected portion 68R can mix with one another to produce a corresponding output light distribution 41R. Similarly, transmitted beam 66B and reflected portion 68B can mix with one another to produce output light distribution 41B; transmitted beam 66G₁ and reflected portion 68G₁ can mix with one another to produce output light distribution 41G₁; and transmitted beam 66G₂ and reflected portion 68G₂ can mix with one another to produce output light distribution 41G₂. In the combined mode of operation, output light distributions 41R, 41G₁, 41G₂ and 41B may combine with one another, throughout the lateral extent of the plane of output end 62 to define a combined output light distribution 71, represented in FIG. 4B using a dashed box.

With ongoing reference to FIG. 4B, in the case of the sequential mode of operation, at least a subset of initial light beams 14R, 14G₁, 14G₂ and 14B can emit light sequentially, in rapid TDM succession. Depending on the embodiment with respect to sequential modes of operation, there may be instants in time at which two or more of the resulting output light distributions 41R, 41G₁, 41G₂ and 41B are not simultaneously present. However, at least insofar as sequential modes of operation can be employed in the context of dynamic updating, output light distributions 41R, 41G₁, 41G₂ and 41B may nevertheless be described as combining with one another to define a time-averaged output light distribution that varies transversely across output surface 62. At least for this reason, time-averaged output light distributions generated by sequential modes of operation may be hereinafter referred to as forming a combined output light distribution 71 that is essentially equivalent to continuous simultaneous source illumination. Therefore, any reference hereinafter to a combined output light distribution may be considered as being applicable with respect to simultaneous and/or sequential combinations of output light distributions, and the present descriptions are in no way intended as being limiting in this regard.

Again referring to FIG. 4A, in various embodiments that are compatible, for example, for use with the 1 mm by 1 mm embodiment of illuminator arrangement 36, input end 60 of lightpipe 40 can have an input height 72 of at least approximately 1.15 mm and an input width 74 of at least approximately 1.3 mm. In this case, the input end is configured to receive at least a majority of any beam of light emitted by the 1 mm by 1 mm illuminator arrangement, and can be aligned according to the projector configuration illustrated in FIG. 2. Output end 62 can have an output height 76 of 1.26 mm, and an output width 78 of 2.16 mm. The lightpipe can be composed of optical glass and/or optical plastic and can have an index of refraction of approximately 1.5, while defining a length 80 that can be determined based on considerations that will be brought to light hereinafter.

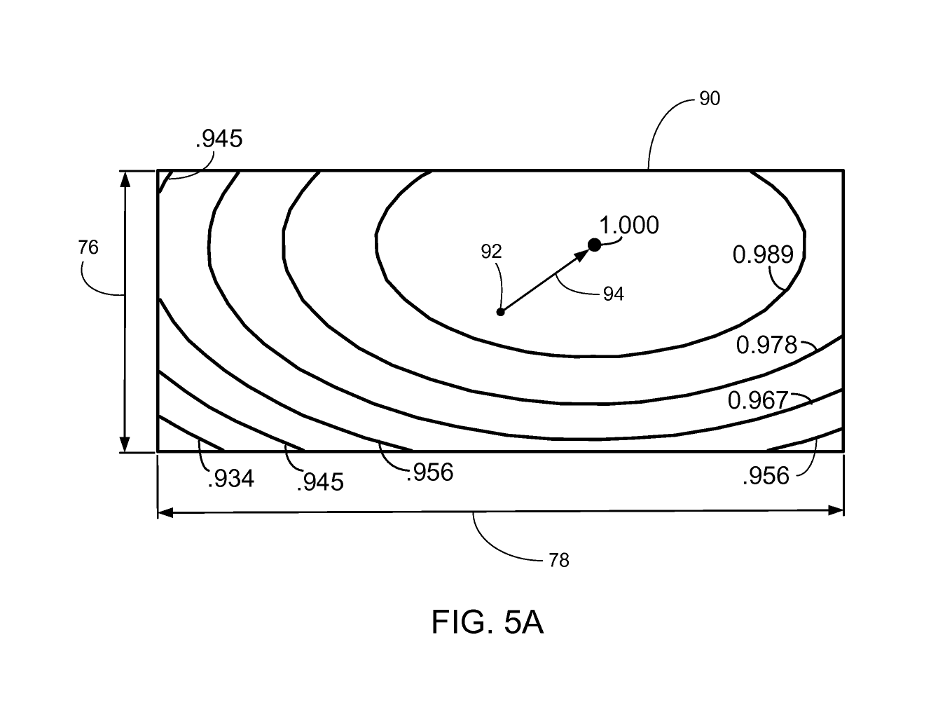

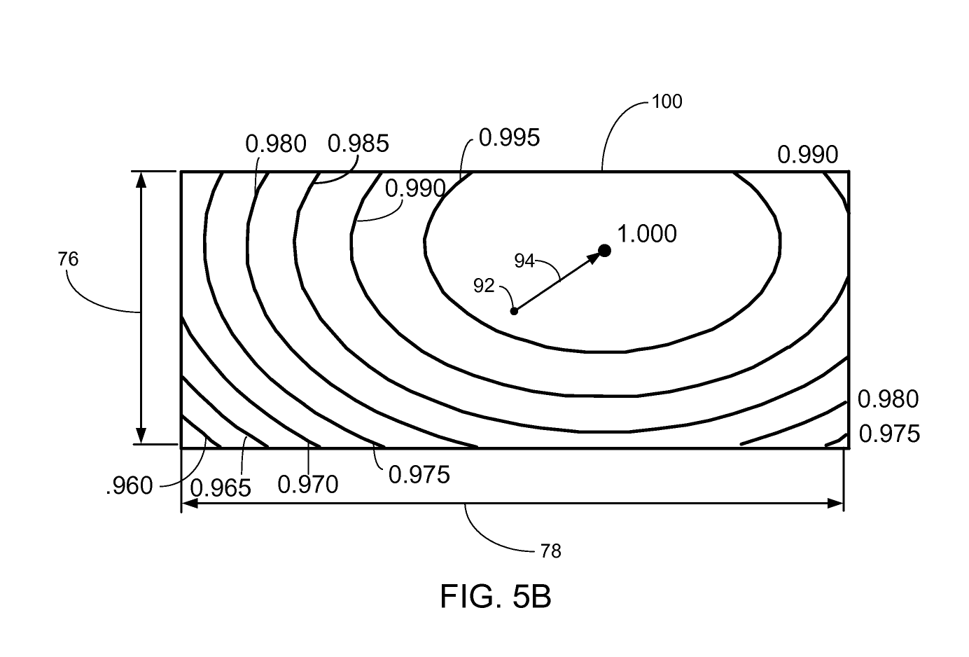

Attention is now turned to FIG. 5A, with ongoing reference to FIGS. 2, 3, 4A and 4B. FIG. 5A illustrates a map 90 of output light distribution 41 that can be produced using a 4 millimeter long embodiment of lightpipe 40, having a length 80 (FIG. 4A) of approximately 4 mm, extending between the aforedescribed 1.15 by 1.3 mm input end and the 1.26 mm by 2.16 mm output end. Map 90 of FIG. 5A is intended as at least approximately representing output light distribution 41R of FIG. 4B, throughout at last a majority of the lateral extents of output surface 62, responsive to activation of light source R of illuminator arrangement 36. Accordingly, the map includes a vertical height 76, indicated using a double-arrow and corresponding to vertical height 76 of output surface 62, and horizontal width 78, indicated using a double arrow and corresponding horizontal width 78 of output surface 62. It is noted that map 90 has been determined based on first order approximations, employing techniques that will be described in greater detail hereinafter.

For purposes of illustrative clarity, output light distribution 90 is divided into regions of differing intensity, all of which regions are delineated by solid lines that serve as boundaries therebetween, such that each solid line represents a selected value of intensity that is constant along that entire line. Based on this convention, FIG. 5A can be interpreted in a manner of interpretation analogous to that of a topological altitude map, wherein the solid lines, representing constant intensity, are analogous to lines of constant altitude. Each solid line is annotated in the figure as corresponding to a designated constant value of intensity, including values ranging from a normalized peak value, designated as 1.000 to a lowest value designated as 0.923. With respect to the descriptions herein, it can be assumed that the intensity from one line to another varies smoothly and monotonically, at least generally without abrupt and/or discontinuous jumps in value between any given pair of adjacent lines. It can be further considered that there is a single point of maximum intensity in the output distribution, as indicated in the figure where the peak value of intensity is illustrated as a point, labeled with the peak normalized intensity value of 1.000.

With ongoing reference to FIG. 5A, in conjunction with FIG. 2, FIG. 3 and FIG. 4B., intensity map 90 represents a first order approximation of output light distribution 41R (FIG. 4B) caused by activation of source R of the 1 mm by 1 mm embodiment of illuminator arrangement 36 (FIG. 3). This first order approximation is based solely on transmitted beam 66R (FIG. 4B), and does not include higher orders of approximation arising from reflected portion 68R (FIG. 4B). In accordance with well known analytical techniques, the first order approximation of map 90 can be produced based at least in part on the simplifying assumptions that each source produces light of constant intensity throughout the lateral extent of that source, and each point on that source emits light in the manner of a Lorentzian point source. While intensity distributions can be determined with higher accuracy, for example, based on advanced ray tracing techniques that will be described in greater detail hereinafter, the first order Lorentzian approximation is considered as being appropriate for descriptive purposes, in part for the reason that these approximations draw particular attention to what is submitted to be the dominant, first order, influence of the transmitted beam. In this regard, it is considered that various clarifying insights, one example of which is described immediately hereinafter, can be brought to light and readily understood in light of these approximations.

In various embodiments, input end 60 can be formed as an at least approximately flat surface, as is depicted in FIGS. 4A and 4B, and this surface can be aligned at least approximately parallel with combined illuminator surface 56 of illuminator arrangement 36 (FIG. 3). Insofar as initial beam of light 14R can initially propagate in a direction that is approximately perpendicular to combined illuminator surface 56, the transmitted beam thereof can be expected to propagate straight through the lightpipe with only minor change in this direction, such that the point of maximum intensity is displaced from a central point 92 by lateral offset 94 indicated in FIG. 5A using an arrow.

Attention is now turned to FIG. 5B, which illustrates a map 100 of output light distribution 41R that can be produced using a 7 millimeter long embodiment of lightpipe 40, having input and output ends of the same size as the shorter, 4 mm long, embodiment of lightpipe 40, and being composed of the same optical material. Map 100 is intended to be interpreted according to the conventions described above with reference to FIG. 5A, and has been generated as a first order approximation based on the same Lorentzian distribution. Based at least on a comparison of intensity values shown in FIG. 5A versus FIG. 5B, a person of ordinary skill in the art can appreciate that the output light distribution of FIG. 5B, produced using the longer, 7 mm lightpipe, exhibits a higher degree of uniformity as compared with that of the shorter 4 mm lightpipe. Furthermore, Applicants have determined and demonstrated that the 7 mm long embodiment of lightpipe 40 may, for many applications, provide sufficient uniformity for use in a high performance projector system. In this regard, it is noted that the normalized intensity of FIG. 5A, associated with the 4 mm long embodiment of lightpipe 40, varies from a maximum value of 1.000 to a minimum value of 0.923, with an intensity difference therebetween of 0.077. By contrast, the intensity of FIG. 5B, associated with the 7 mm long embodiment of lightpipe 40, varies from 1.000 to 0.955, corresponding to a smaller intensity difference of 0.045. Based at least on the foregoing comparison, it can be expected that the 7 mm long embodiment of lightpipe 40 should produce an output light distribution having a degree of intensity uniformity that is at least approximately 40% higher as compared to that of the shorter, 4 mm long, embodiment.

The first order approximations of output light distribution 41R, based on transmitted portion 68R of non uniform light, have been included for purposes of enhancing the readers understanding. However, the reflected portion of light further influences the output light distribution, across output end 62 of the lightpipe. It is noted that in many cases the presence of the reflected portion, as part of the output light distribution, generally tends to result in a somewhat higher degree of intensity uniformity than that which would be predicted solely based on the first order approximation. It is further noted that the lightpipe may be configured to cause internal reflection based on a variety of mechanisms. In one embodiment, by way of non-limiting example, the lightpipes described herein can be configured such that the reflectivity of the tubular surface is based on total internal reflection (TIR), well known to those of ordinary skill in the art. In cases of total internal reflection, for any light glancing at sufficiently shallow angles θ (FIG. 4A), from inside the lightpipe, a difference between the index of refraction of the lightpipe and that of the surrounding media, such as air, can cause a high degree of internal reflection, often with near perfect efficiency. While FIG. 4A illustrates only one ray of light internally reflecting at only one location on tubular surface 62, it should be appreciated that reflected portion 68 may propagate in complex ways, with some portions thereof reflected only once before exiting the lightpipe through output end 62, and other portions reflecting more than once.

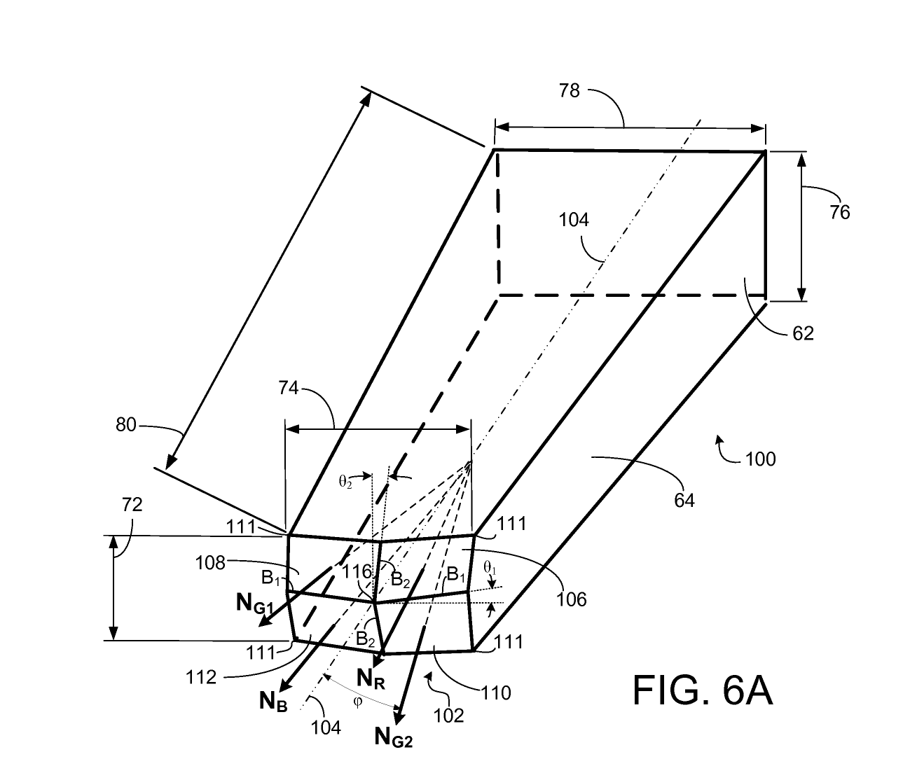

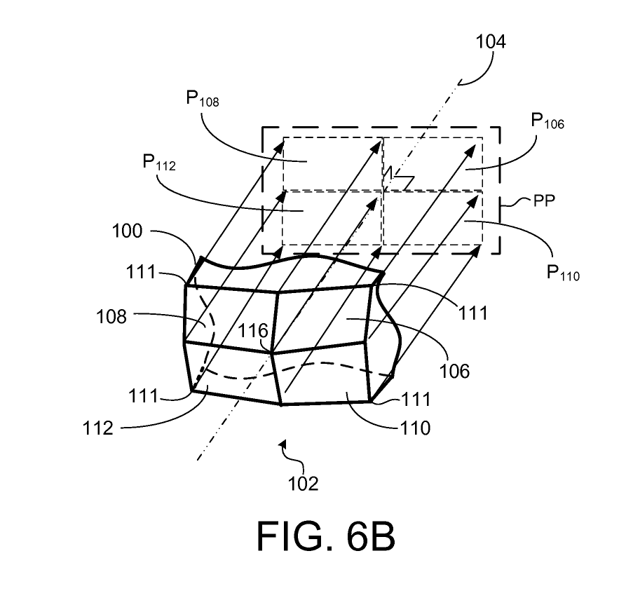

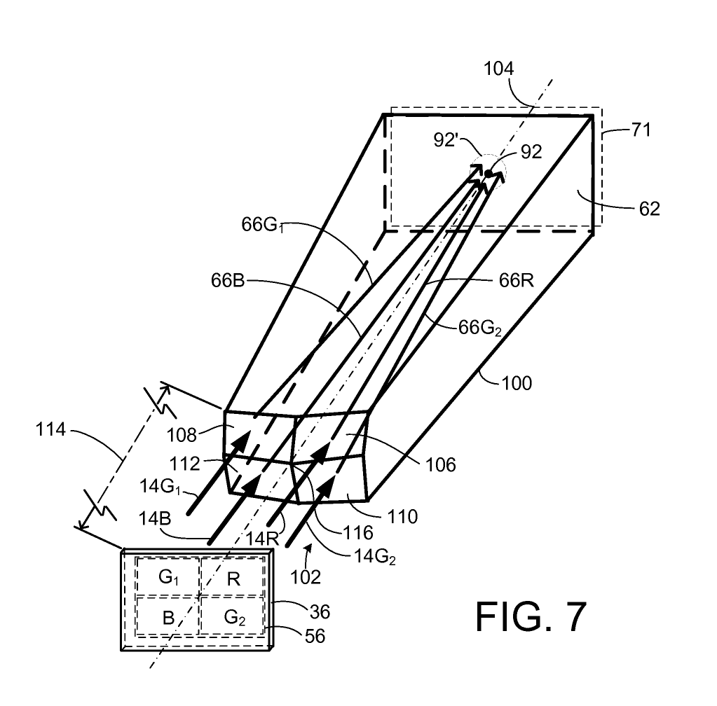

Attention is now directed to FIG. 6A, which illustrates a diagrammatic perspective view of a faceted lightpipe generally indicated by reference number 100, having a faceted input end 102, an output end 62, and a tubular sidewall surface 64 extending therebetween. The faceted lightpipe defines an optical axis 104 that extends lengthwise therethrough from faceted input end 102 to output end 62. Tubular sidewall surface 64 defines a closed cross section of the lightpipe, having a rectangular shape such that at least the output end is approximately rectangular. The tubular surface can be tapered to define a frusto-pyramidal shape that delineates the body of the faceted lightpipe, which body can be integrally formed with a faceted input end having four facets 106, 108, 110 and 112. As will be described in further detail immediately hereinafter, each of the facets can be formed as being at least generally planar, such that a peripheral outline of each facet is in the shape of a quadrilateral, and an orthographic projection of each quadrilateral, onto any projection plane that is perpendicular to optical axis 104, at least approximately defines a rectangle. Each facet can be oriented to face in a direction, outward from lightpipe, that is at least approximately normal to that facet, as indicated in the figure using a normal vectors N_{R}, N_{G1}, N_{G2}, N_{B} associated with each surface, and directions of each facet diverges away from the optical axis, at an acute angle φ therewith.

With ongoing reference to FIG. 6A, it is noted that one embodiment of faceted lightpipe 100, suitable for use with illuminator arrangement 36, can be formed of an optical material having an index of refraction of approximately 1.5 with the input end having width 74 of approximately 1.3 mm, and height 72 of approximately 1.15 mm. The output end may have width 78 of approximately 1.26 mm, and height 76 of approximately 2.16 mm. Length 80 of the faceted lightpipe can be approximately 4 mm, and the facets may each be tilted, in a direction from apex 116 to each corner 111, by angle φ. This tilt can be specified, using angles θ₁ and θ₂ (see FIG. 6A) as predetermined angles between boundaries B₁ and B₂ of the facets and a reference plane (not shown) that is perpendicular to lightpipe axis 104. In particular the facets may be tilted such that θ₁=θ₂ with both angles having the same value of approximately 9.6 degrees. It is noted that for this case, angle φ can have a value of approximately 14.3. It is further noted that the foregoing dimensions are in no way intended as being limiting, and the faceted lightpipe can be configured based on different dimensions, the suitability of which can depend on various factors including but not limited to configurations and locations of the illuminator arrangement, the detector, and the displacement lens.

Further details with respect to the faceted input end are illustrated in FIG. 6B, which shows a cutaway view of an input portion of faceted lightpipe 100. FIG. 6B illustrates the peripheral outline of each facet, using solid lines. A given projection plane PP, perpendicular to optical axis 104, is illustrated using dashed lines. The orthographic projections associated with facets 106, 108, 110 and 112, are illustrated using dashed lines and have been indicated using the reference numbers P₁₀₆, P₁₀₈, P₁₁₀ and P₁₁₂, respectively. It is noted, as illustrated in FIG. 6B, that the facets can be arranged in side-by-side relationships with one another such that each rectangular projection lies in one quadrant of the projection plane.

With ongoing reference to FIGS. 6A and 6B, it is noted that the facet surfaces adjoin to define boundaries B₁ and B₂ between adjacent facets, and it can be expected that some degree of light scattering may be caused by at least portions of these boundaries. For at least this reason, it can be desirable to provide for thin and/or sharply defined boundaries. The immediately foregoing descriptions are in no way intended as being limiting and the facets can be configured in any suitable shape. Furthermore, there is no requirement that the facets be planar, and in some cases it can be advantageous to configure at least a selected facet to have a curved, non-planar shape, to cause the facet to diffract initial light rays 14 n a manner that can depends at least in part on the location of each light ray on the selected facet.

Attention is now turned to FIG. 7, which is a diagrammatic illustration, in perspective, of faceted lightpipe 100 in series with Illuminator arrangement 36. The illuminator arrangement is oriented with individual light sources R, G₁, G₂, and B facing towards faceted input end 102 at a distance 114 between an apex 116 of input end 102 and combined surface 56 of illuminator arrangement 36. Input end 102 is aligned such that sources R, G₁, G₂ and B each align with an associated one of facets 106, 108, 110, and 112, respectively. In order to facilitate high efficiency, such that a majority of each light beam 14R, 14G₁, 14G₂, and 14B is received by its associated facet, distance 114 can be extremely short, such that the illuminator arrangement is practically touching apex 116. As one non-limiting example, distance 114 may have a value in the range from 0.05 mm to 0.2 mm, inclusively. It is noted that FIG. 7 is not drawn to scale, and distance 114 is highly exaggerated for purposes of illustrative clarity, as indicated in the figure using a broken arrow. It is further noted that sources R, G₁, G₂ and B are illustrated, in phantom, using dashed lines in order to indicate, in perspective, that the light sources are facing toward the lightpipe.

Initial beams of light 14R, 14G₁, 14G₂ and 14B can emit from their associated light sources R, G₁, G₂ and B, respectively, such that at least a majority of each beam is received by its associated facet, as illustrated in FIG. 7. At least insofar as combined illuminator surface 56 (FIG. 3) is approximately planar, the initial beams of light can all be emitted in the same initial direction at least approximately parallel with optical axis 104. All four of transmitted beams 66R, 66G₁, 66G₂ and 66B can be bent, by their associated facets 106, 108, 110 and 112, to converge toward optical axis 104. Based on well known principles of optics, each facet can refractively bend the initial beam of light associated therewith by an amount that can depends at least in part on the values of θ₁ and θ₂. Based at least in part on this refraction, the faceted input end can be configured such all of the transmitted beams converge toward the optical axis. In various embodiments, the faceted input end can be configured to bend the initial beams of light to converge the transmitted beams toward optical axis 104 into a central region 92′ of output surface 62, indicated in FIG. 7 using a dashed line, surrounding a central point 92.

As described previously, with reference to FIGS. 4A and 4B, and throughout the present disclosure as a whole, each of the initial beams of light produces an associated transmitted beam, as a portion thereof, that can propagate directly through the lightpipe to exit through output surface 62 without impinging upon any portion of the tubular surface, while a reflected portion can be reflected by the tubular sidewall to propagate reflectively through the lightpipe. For purposes of illustrative clarity, the reflected portions, described previously with reference to FIGS. 4A and 4B, are omitted from FIG. 7. However, as described with respect to non-faceted lightpipe 40, the transmitted breams and reflected portions, associated with each of initial beams of light 14R, 14G₁, 14G₂ and 14R, can produce output light distributions 41R, 41G₁, 41G₂ and 41B, respectively, and these output light distributions can combine, across output end 62 to produce combined output light distribution 71.

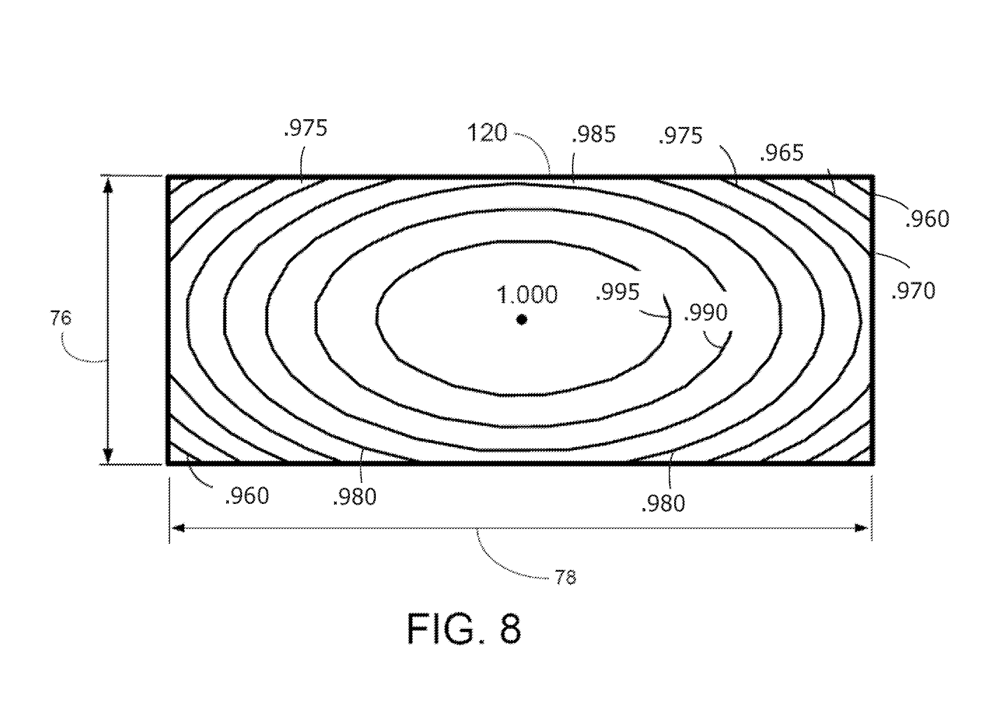

Attention is now turned to FIG. 8, which illustrates a map 120 depicting a particular output light distribution 41R that can be produced by activation of source R of the 1 mm by 1 mm embodiment of illuminator arrangement 36, using a 4 millimeter long embodiment of faceted lightpipe 100 of FIG. 7. The input end of faceted lightpipe 100 can be formed with a height 72 of 1.15 mm and a width 74 of 1.3 mm, as indicated in FIG. 8 using double-headed arrows, while output end 62 can have a height 76 of 1.26 mm and a width 78 of 2.16 mm. Map 120 can be interpreted according to the conventions described above with referenced to FIGS. 5A and 5B, and has been generated as a first order approximation based on Lorentzian distributions. As described with reference to FIG. 7, facets 106, 108, 110 and 112 can be configured to receive and bend associated initial beams of light 14G₁, 14G₂ and 14B such that all of the associated output light distributions converge toward optical axis 104 (FIG. 7). It can be appreciated that the facets can be further configured to cause a sufficient degree of convergence such that one or more of the output light distributions are at least approximately centered with respect to output end 62 of faceted lightpipe 100. In this regard, while the descriptions with reference to FIG. 8 have been framed with regard to output light distribution 41R produced by light source R, it should be understood that FIG. 8 can be regarded as equally applicable in terms of representing normalized output light distributions 41G₁, 41G₂ and 41B, produced by any desired activation of sources G₁, G₂ and B, respectively, at least for embodiments wherein all the facets are oriented for at least approximately centering their associated output light distribution.

Based at least on a comparison of intensity values in FIG. 8 to those of FIG. 5A, it can be appreciated that faceted 4 mm long lightpipe 120 provides for a higher degree of intensity uniformity as compared with the 4 mm long embodiment of non-faceted lightpipe 40. In particular, it is noted that the total intensity variation associated with the 4 mm long embodiment of faceted lightpipe 100 as determined based on FIG. 8, is the difference between a maximum value 1.000 normalized intensity and a minimum value of 0.955, is approximately 0.045, while the total intensity variation associated with the 4 mm long embodiment of non-faceted lightpipe 40, is approximately 0.077. These results are discussed in detail immediately hereinafter.

Based on the foregoing descriptions, the 4 mm long faceted lightpipe 100 exhibits at least somewhat comparable intensity uniformity as compared to the 7 mm long embodiment of non-faceted lightpipe 40. Therefore, at least in some applications, substitution of 4 mm long faceted lightpipe 100 in place of the 7 mm long embodiment of non-faceted lightpipe 40, can result in least generally comparable performance, while providing for size reduction of at least approximately 3 mm in lightpipe length 80. The resulting space saving, due to use of the shorter lightpipe, can be highly beneficial at least in the context of projectors that are to be included in compact and/or handheld devices such as cell phones and smartphones where small size and volume can be at a premium for a variety of components therein. In general, in order to meet or exceed a given set of requirements for intensity uniformity with respect to illumination of the display of a given projector system, a person of ordinary skill in the art, having this disclosure in hand, will recognize that the use of a faceted lightpipe can be expected to facilitate space savings, at least for a variety of projector applications in which lightpipes are useable.

While first order approximations, as described with reference to FIGS. 5A, 5B and FIG. 8, are considered sufficiently accurate at least for descriptive purposes, and for purposes of comparison between different lightpipe embodiments, it can be beneficial to determine and consider more accurate representations of output light distributions. At least in order to account for reflected portions of the initial light beams, to verify the validity of comparisons based on first order approximations and to shed further light on absolute performance characteristics of various lightpipe embodiments, performance plots having greater accuracy will be described immediately hereinafter. Furthermore, as will be described in greater detail immediately hereinafter, it can be appreciated that a high degree of intensity uniformity associated with each individual one of plurality of homogenized beams can tend to facilitate correspondingly high degree of intensity uniformity with respect to the combined output light distribution.

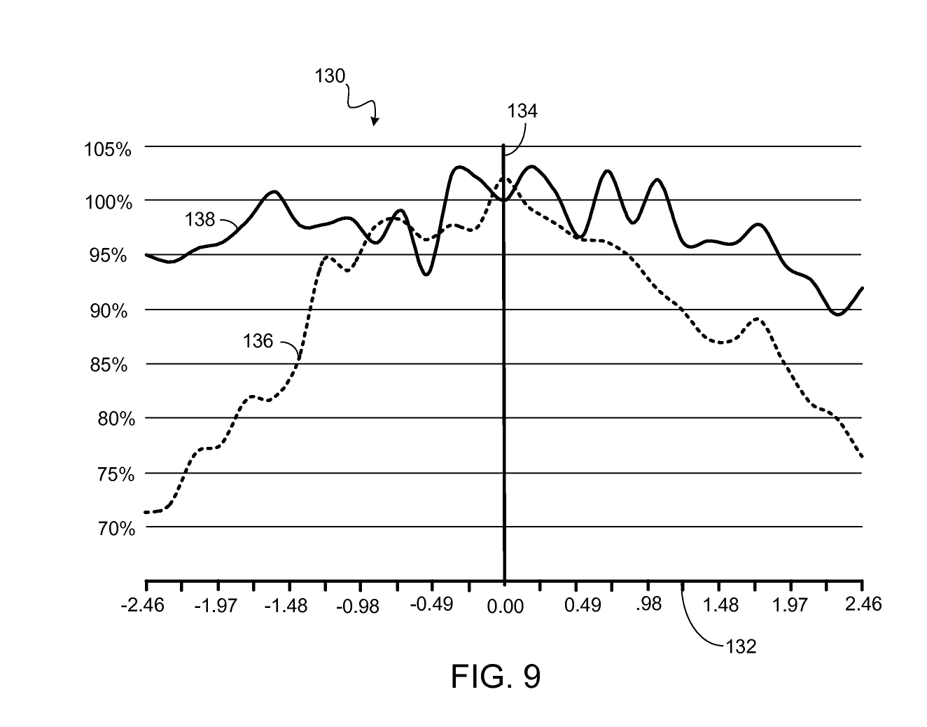

Attention is now turned to FIG. 9, which is a graph of luminance cross-section, generally indicated by reference number 130, plotting cross-sections of intensity variation for combined output light distributions of two different lightpipe embodiments. A horizontal axis 132 indicates a widthwise lateral position, in millimeters, across a center line of the display, and a vertical axis 134 represents normalized intensity based on a normalized intensity scale from 0.0 to 1.0 with the center of the display having a normalized intensity of 1.000. The plots of FIG. 9 have been computed using TracePro® ray tracing software in order to simulate imaging of combined output distribution 71 by displacement lens 42 onto display 10.

A first plot 136 indicates intensity variation of the combined output light distribution, for the 4 mm long embodiment of non-faceted lightpipe 40, based on a combined mode of operation in which the combined output light distribution is caused by simultaneous activation of sources R, G₁, G₂, and B. First plot 136 illustrates a total intensity variation corresponding to about 26%.

A second plot 138 indicates intensity variation of the combined output light distribution, for the 4 mm long embodiment of faceted lightpipe 100, and indicates intensity variation of the combined output light distribution resulting from the same mode of operation, with sources R, G₁, G₂, and B simultaneously activated. Plot 138 indicates a total intensity variation corresponding to roughly 10% total intensity variation. Accordingly, a faceted lightpipe that is configured for converging input beams of received light can provide increased intensity uniformity as compared with non-faceted embodiments. While the plots of FIG. 9 have been generated for a mode of operation in which all four light sources are simultaneously activated, a person of ordinary skill in the art, having this application in hand, can readily confirm similar results in the context of various modes in which different combinations of light sources are activated in a sequential manner.

With regard to embodiments of color projectors that rely on color mixing of a plurality of different color light sources, including but not limited to color projectors that utilize red, green and blue light sources, it can be appreciated that a high degree of intensity uniformity in the illumination of display 10, can further provide for a correspondingly high degree of color uniformity in the illumination of the display, and hence in projected images 26 (FIG. 2). While it is considered that a person of ordinary skill in the art, familiar with projector systems, can readily appreciate this well known correspondence with regard to intensity uniformity and color uniformity, explicit comparisons will be presented, for purposes of completeness, illustrating color uniformity for faceted and non-faceted lightpipe embodiments.

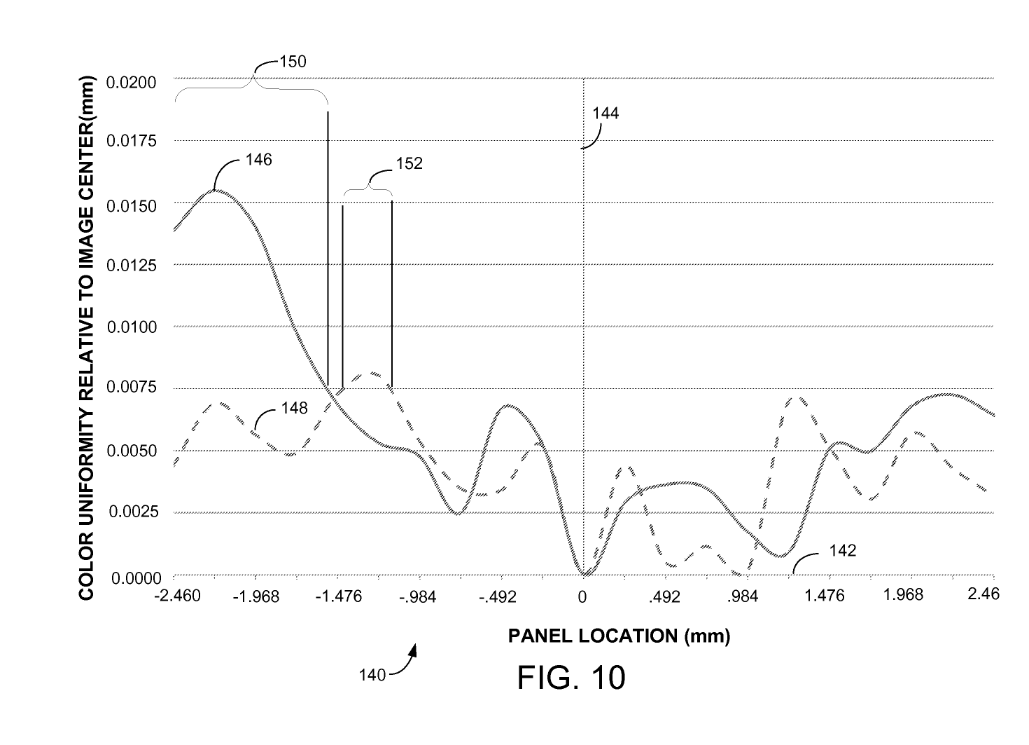

Attention is now turned to FIG. 10, which is a graph of color uniformity, generally indicated by reference number 140, plotting color values, in the context of the same arrangements described with reference to FIG. 9 configured for illumination of display 10. A horizontal axis 142 indicates a width wise lateral position, in millimeters, across a center line of the display, and a vertical axis 144 represents color uniformity values based on well known ANSI standard algorithms for characterizing color uniformity, with a reference value of zero corresponding to a central location of the combined output light distribution. For purposes of enhancing the reader's understanding with regard to interpretation of FIG. 10, it is noted that ideal illumination of display 10, with perfectly white and perfectly uniform light, should be interpreted, based on the ANSI standard algorithm for characterizing the color uniformity, as corresponding to a constant value of 0.0 across any cross section of the display. Furthermore, based on this standard as it applies in FIG. 10, it is noted that deviations of color value exceeding 0.0075 tend to be discernible, at least for a person having excellent eyesight, while deviations under this value may be at least generally indiscernible.

A first plot 146 represents color variations throughout a width-wise cross-section of the combined output light distribution for the 4 mm long embodiment of non-faceted lightpipe 40 with all sources R, G₁, G₂, and B simultaneously activated as red, green, green, and blue colors, respectively. In accordance with well known principles of optics based on this combination of colors, the resulting color can be expected to be at least approximately white throughout at least a majority of combined output light distribution associated with the lightpipe. As described above with reference to the ANSI standard algorithm, deviations from pure whiteness, irrespective of whether those deviations arise from the source, the lightpipe, or the displacement lens, are represented in plot 136 as a set of non-zero values.

A second plot 148 represents color uniformity based on the 4 mm long embodiment of faceted lightpipe 100. As described previously, deviations in color value greater than 0.0075 can be discerned by a typical person having excellent eyesight. However, noticeability of image degradation with respect to deviations exceeding this amount may further depend on the lateral extent over which the deviation occurs. As one non-limiting example, a deviation 150 in plot 146, associated with the non-faceted flat-faced lightpipe, is indicated in the figure using a bracket. Deviation 150 substantially exceeds 0.0075 over a wide lateral extent, and is least likely to be associated with highly visible color deviation. These deviations can correspond to substantially more noticeable image degradation as compared with a smaller deviation 152, associated with the faceted lightpipe, which is both narrower and lower than deviation 150. As described above, plot 140 represents a single width-wise cross section. While a number of other cross sections associated with the 4 mm long embodiment of faceted lightpipe 100 may include deviations that are somewhat larger than those plotted in FIG. 1, it has been demonstrated that for at least a majority of cross sections, the faceted lightpipe produces smaller deviations than the flat faced lightpipe at least generally in accordance with plot 146. For at least these reasons, the faceted lightpipe can provide a higher degree of color uniformity as compared with the flat-faced lightpipe. Furthermore, a person of ordinary skill in the art, employing well known computational techniques, can generate true color images (not shown) in order to further demonstrate that a given faceted lightpipe of a predetermined length can produce images of higher color uniformity relative to a given flat faced lightpipe of the same length.

In view of the foregoing, Applicants have described lightpipe arrangements suitable for use as homogenizers in a compact high performance projection system that incorporates a state-of-the-art illuminator arrangement having a plurality of light sources. Embodiments of the lightpipe arrangement can cooperate with the illuminator arrangement to provide for a combined output distribution having a high degree of uniformity with respect to color and intensity. Furthermore, the use of the disclosed lightpipe arrangement is submitted to provide further benefits, heretofore unseen, including facilitating a compact size profile associated with the projector system. However, foregoing descriptions are in no way intended as being limiting, and the teachings of the present disclosure can be readily practiced in larger scale devices. For example, the projector system could be sufficiently large, and sufficiently bright, for use in conference rooms and/or lecture halls.

The foregoing description of embodiments of the invention has been presented for purposes of illustration and description. It is not intended to be exhaustive or to limit embodiments of the invention to the precise form or forms disclosed, and other modifications and variations may be possible in light of the above teachings wherein those of skill in the art will recognize certain modifications, permutations, additions and sub-combinations thereof.

What is claimed is:

1. An optical assembly comprising:
a plurality of light sources each capable of emitting a light beam associated therewith; and
a lightpipe that is configured to transmit the light beams emitted from the plurality of light sources from an input end to an output end of the lightpipe,
wherein the input end is configured to bend at least a first transmitted light beam towards a second transmitted light beam, to cause associated first and second transmitted beam paths to converge while thereafter traveling toward the output end.

2. The optical assembly of claim 1 wherein the lightpipe includes a tubular sidewall surface, having a length, extending therebetween, and the input end is aligned to receive each of the light beams, and each light beam travels through the lightpipe and includes a transmitted beam that propagates directly through the lightpipe, at least generally along a transmitted beam path, without impinging on the tubular sidewall, and a reflected portion that internally reflects from the tubular sidewall.

3. The optical assembly of claim 1 wherein the input end is configured to cause the transmitted beam paths associated with each transmitted beam to converge toward a central region of the output surface.

4. The optical assembly of claim 3 wherein each light source is configured to cooperate with the lightpipe to produce an output light distribution, at the output end of the lightpipe, having light intensity that varies transversely across the output surface of the lightpipe such that each output light distribution includes a transmitted light distribution and a reflected light distribution, produced by the transmitted beam and reflected portion, respectively, of the emitted light beam, and the input end is further configured such that the convergence of the transmitted beam paths causes at least the transmitted light distributions to converge toward a central region of the output end of the lightpipe.

5. The optical assembly of claim 4 wherein each light source is configured such that the transmitted light distributions each exhibit at least approximately the same transverse intensity variation, and the convergence of the transmitted beam paths causes the transmitted light distributions to at least approximately transversely coincide with one another.

6. The optical assembly of claim 4 wherein each light source is configured such that the associated transmitted light distribution includes a region of peak intensity, as a transverse portion thereof, that exhibits higher intensity as compared with other transverse portions of that transmitted light distribution, and
the lightpipe is configured to converge the transmitted beam paths such that the regions of peak intensity of the transmitted light distributions move toward the central region of the output end of the lightpipe upon approaching the output end.

7. The optical assembly of claim 6 wherein the input end further configured such that convergence of the transmitted beam paths is of a sufficient extent to cause the regions of peak intensity to approximately overlap with one another.

8. An optical assembly comprising:
a plurality of light sources, each of which light sources configured to emit a light beam associated therewith;
a lightpipe having a faceted input end and an output end, and an optical axis that extends lengthwise therethrough from the faceted input end to the output end,
the faceted input end includes a plurality of facets with each facet positioned such that light beams transmitted through the lightpipe from each of the facets converge upon approaching the output end.

9. The optical assembly of claim 8 further comprising each of the facets formed as at least generally planar, and each facet faces in a direction, outward from lightpipe, that is at least approximately normal to that facet, and the direction of each facet diverges away from the optical axis at an acute angle therewith.

10. The optical assembly of claim 8 further comprising each facet is configured to bend the transmitted beam associated therewith in a way that depends at least in part on the orientation of that facet, and the facets are cooperatively oriented, differently from one another, such that the transmitted beam paths converge within the length of the lightpipe.

11. The optical assembly of claim 10 further comprising each light source configured to produce, at the output end of the lightpipe, an output light distribution having light intensity that varies transversely across the output surface of the lightpipe,
wherein each output light distribution includes a transmitted light distribution and a reflected light distribution, produced by the transmitted beam and reflected portion, respectively, of the emitted light beam.

12. The optical assembly of claim 11 further comprising the facets are oriented such that the convergence of the transmitted beam paths causes the associated the transmitted light distributions to converge, toward a central region of the output end of the lightpipe.

13. The optical assembly of claim 12 further comprising the light sources configured such that the transmitted light distributions each exhibit at least approximately the same transverse intensity variation, and the extent of convergence of the transmitted beam paths is of a sufficient extent to cause at least a subset of transmitted light distributions to transversely coincide with one another, at least to an approximation.

14. The optical assembly of claim 13 wherein the plurality of light sources includes at least one red light source, at least one green light source, and at least one blue light source.

15. The optical assembly of claim 11 further comprising the illumination apparatus is operable in a combined mode of operation wherein the light sources emit light beams at the same time, and the output light distributions of the light sources add with one another to provide a combined output light distribution having a light intensity that varies transversely across the output surface of the faceted lightpipe; and
the combined output light distribution, in the combined mode of operation, exhibits an amount of total intensity variation,
wherein the faceted lightpipe is configured to converge the transmitted beams of light to cause a reduction of the amount of total intensity variation at the output end, as compared to a non-faceted lightpipe having a flat input end.

16. The optical assembly of claim 15 wherein the output distribution includes a range of light intensity values, including a lowest value of light intensity and a highest value of light intensity, such that the total intensity variation is a difference between the lowest and highest values of light intensity.

17. The optical assembly of claim 11 further comprising the illumination apparatus is operable in a sequential mode of operation in which mode at least a subset of the light sources emit light sequentially, one after the other, and the output light distributions associated with each of the subset of sources combine to define an average output light distribution that varies transversely across the output surface of the faceted lightpipe, such that the average output light distribution, for the sequential mode of operation, exhibits an amount of total intensity variation,
wherein the convergence of the transmitted beams of light causes a reduction of the amount of total intensity variation at the output end as compared to a non-faceted lightpipe having a flat input end.

18. The optical assembly of claim 17 wherein the output distribution includes a range of light intensity values, including a lowest value of light intensity and a highest value of light intensity, such that the total intensity variation is a difference between the lowest and highest values of light intensity.

19. The optical assembly of claim 11 further comprising a first one of the light sources selectively emit light of one color, and a second one of the light sources is configured to emit light of a second color, and at least a third one of the light sources is configured to selectively emit light of a third color, and
the illumination apparatus can be operated in a combined mode of operation wherein at least the first second and third light sources emit light beams at the same time, and the output light distributions of the two or two light sources add with one another to provide a combined output light distribution having a color that varies transversely across the output surface of the faceted lightpipe, such that the combined output light distribution, in the combined mode of operation, exhibits an amount of color variation,
wherein the faceted lightpipe is configured to converge the transmitted beams of light to cause a reduction of the amount of intensity variation at the output end as compared to a non-faceted lightpipe having a flat input end.

20. The optical assembly of claim 11 further comprising a first one of the light sources is configured to selectively emit light of one color, and a second one of the light sources is configured to emit light of a second color, and at least a third one of the light sources is configured to selectively emit light of a third color, and the illumination apparatus can be operated in a sequential mode of operation in which at least the first, second and third light sources emit sequentially, one after the other, and the output light distributions associated with each of the subset of sources all combine to define an average output light distribution having a color that varies transversely across the output surface of the faceted lightpipe, such that the average output light distribution, for the sequential mode of operation, exhibits an amount of color variation,
wherein the faceted lightpipe is configured to converge the transmitted beams of light to cause a reduction of the amount of color variation at the output end as compared to a non-faceted lightpipe having a flat input end.

21. A faceted lightpipe, for receiving a plurality of light beams, the faceted lightpipe comprising:
a faceted input end having a plurality of facets, an output end, a sidewall surface extending between the faceted input end and the output end, and an optical axis that extends through the lightpipe from the faceted input end to the output end, wherein each of the facets is formed as at least generally planar, and each facet faces in a direction, outward from lightpipe, that is at least approximately normal to that facet, and the direction of each facet diverges away from the optical axis, at an acute angle therewith.

22. The faceted lightpipe of claim 21, further comprising the sidewall is tapered to define a rectangular frusto-pyramidal shape.

23. The faceted lightpipe of claim 22 wherein the faceted input includes four facets, and a peripheral outline of each facet is in the shape of a quadrilateral, such that an orthographic projection of each quadrilateral, onto any projection plane that is perpendicular to the optical axis, at least approximately defines a rectangle.

24. An optical assembly, for use with an image projector, the optical assembly comprising:
an illuminator arrangement including a plurality of light sources, each of which light sources selectively emits a light beam associated therewith;
a lightpipe that defines a faceted input end, an output end, a tubular sidewall surface extending therebetween, and an optical axis that extends along a length of the lightpipe from the faceted input end to the output end with the input end aligned to receive each of the light beams such that each light beam travels through the lightpipe including a transmitted beam that propagates directly through the lightpipe, at least generally along a transmitted beam path, without impinging on the tubular sidewall, and a reflected portion that internally reflects from the tubular sidewall, and
the faceted input end defines a plurality of facets, and each facet is formed as at least generally planar and is aligned to receive one of the transmitted beams.

25. The optical assembly of claim 24 wherein the lightpipe defines a length, and each facet faces in a direction, outward from lightpipe, that is at least approximately normal to that facet, and the direction of each facet diverges away from the optical axis, at an acute angle therewith, to cause each facet to bend the transmitted beam received thereby, and a first one of the facets bends a first one of the transmitted beams towards a second one of the transmitted beams to converge the first and second transmitted beam paths within the lightpipe upon approaching the output end.

26. A projection system comprising:
an illuminator arrangement including a plurality of light sources each of which light sources selectively emits an initial light beam associated therewith,
a lightpipe that defines a faceted input end, an output end, a tubular sidewall surface extending therebetween, and an optical axis that extends lengthwise therethrough from the faceted input end to the output end with the input end aligned to receive each of the initial light beams such that each initial light beam travels through the lightpipe and includes a transmitted beam that propagates directly through the lightpipe, at least generally along a transmitted beam path, without impinging on the tubular sidewall, and a reflected portion that internally reflects from the tubular sidewall, and
the faceted input end defines a plurality of facets with each facet aligned to receive one of the initial light beams, and each facet is oriented to bend the transmitted beam associated therewith in a way that depends at least in part on the orientation of that facet, and the facets are cooperatively oriented, differently from one another, such that the transmitted beam paths converge to produce at the output end of the lightpipe, a combined output distribution having light intensity that varies transversely across the output surface of the lightpipe,
a display defining a display shape;
a lens that is aligned to receive the output light distribution and to direct the output light distribution toward a beamsplitter, which beamsplitter is configured to redirect the combined output light distribution for incidence on the display to illuminate the display, and the lens is configured to focus the combined output light distribution at the display in a way that matches the display shape, and
the display is configured to receive an electrical signal and to emit an object image, responsive to the combined output distribution, based on the electrical signal, for subsequent projection of the object image;
an imaging lens arrangement including a set of one or more lenses, defining a lens axis, an entrance side and an exit side, and configured to cooperate with the beamsplitter for receiving and imaging the object image that passes through the beamsplitter, following emission by the display, and is received at the entrance side to propagate through the set of lenses, at least generally along the lens axis, to produce a projected image, based on the object image, that exits the projection lens arrangement from the exit side.
